(19) United States
(12) Patent Application Publication
(10) Pub. No.: US 2026/0228903 A1
(43) Pub. Date: Aug. 6, 2026

(54) Real-Time Tracking Based on Dense Calibrated Camera Coverage

(71) Applicant: TRIGO VISION LTD., Ramat Gan (IL)

(72) Inventors: Ido Marcus, Tel Aviv-Jaffa (IL); Elad Malka, Tel Aviv (IL); Lihi Ahuva Shiloh-Perl, Ramat Gan (IL); Daniel Kopolovich, Etz Efraim (IL); Keren Ben Zvi, Tel Aviv (IL); Guy Lapid, Ness Ziona (IL); Itai Alpern, Tel Aviv-Yafo (IL); Eyal Daniel, Ramat Gan (IL); Itamar Winter, Ramat Gan (IL)

(21) Appl. No.: 19/256,250

(22) Filed: Jul. 1, 2025

Related U.S. Application Data
(60) Provisional application No. 63/752,887, filed on Feb. 3, 2025.

(51) Int. Cl. G06T 7/292; G06T 7/80

(52) U.S. Cl. CPC G06T 7/292; G06T 7/80; G06T 2207/30196; G06T 2207/30244

(57) ABSTRACT

A tracking system includes an interface, a memory, and one or more processors. The interface is configured to receive images acquired by a plurality of video cameras installed in a region. The memory is configured to store calibration data that specifies geometrical positions and orientations of respective Fields-Of-View (FOVs) of the cameras. The one or more processors are configured to, based on the images and the calibration data, distinguish between multiple individuals present in the region, and track geometrical paths taken by the individuals in the region.

### CROSS-REFERENCE TO RELATED APPLICATIONS

This application claims the benefit of U.S. Provisional Patent Application 63/752,887, filed Feb. 3, 2025, whose disclosure is incorporated herein by reference.

### FIELD OF THE INVENTION

The present invention relates generally to tracking of individuals based on video footage, and particularly to methods and systems for tracking individuals in areas densely covered by calibrated video cameras.

### BACKGROUND OF THE INVENTION

Tracking of people based on video footage is useful in a wide variety of applications. One typical example is tracking shoppers in a retail store, e.g., for automatic generation of a shopping list in an automated store or for theft prevention. An example algorithm of this sort is described by Yang et al., in “A Unified Multi-view Multi-person Tracking Framework,” arXiv:2302.03820v1, Computational Visual Media, February 2023.

### SUMMARY OF THE INVENTION

An embodiment that is described herein provides a tracking system including an interface, a memory, and one more processors. The interface is configured to or receive images acquired by a plurality of video cameras installed in a region. The memory is configured to store calibration data that specifies geometrical positions and orientations of respective Fields-Of-View (FOVs) of the cameras. The one or more processors are configured to, based on the images and the calibration data, distinguish between multiple individuals present in the region, and track geometrical paths taken by the individuals in the region by: (1) calculating multiple tracklets, each tracklet defining a geometrical path of a given individual in a 2D coordinate system of a given camera over a time segment, (2) forming multiple clusters, each cluster including a set of one or more tracklets that (i) originate from one or more different cameras, (ii) occur in a given time segment, and (iii) are estimated to represent a same individual, including, in forming the clusters for a given time segment, applying a predefined geometrical restriction that rules out two or more tracklets obtained from different cameras from representing the same individual, and (3) deriving the geometrical paths from the clusters.

There is additionally provided, in accordance with an embodiment of the present invention, a tracking system including an interface, a memory, and one or more processors. The interface is configured to receive images acquired by a plurality of video cameras installed in a region. The memory is configured to store calibration data that specifies geometrical positions and orientations of respective Fields-Of-View (FOVs) of the cameras. The one or more processors are configured to, based on the images and the calibration data, distinguish between multiple individuals present in the region, and track geometrical paths taken by the individuals in the region by:
1. Calculating multiple tracklets, each tracklet defining a geometrical path of a given individual in a 2D coordinate system of a given camera over a time segment;
2. Forming multiple clusters, each cluster including a set of one or more tracklets that (i) originate from one or more different cameras, (ii) occur in a given time segment, and (iii) are estimated to represent a same individual, including, for a given time segment, forming the clusters in a clustering process having at least first and second phases, by: (i) assigning one or more pairs of tracklets to the first phase of the clustering process, according to a first clustering metric, (ii) clustering the pairs assigned to the first phase, the clustering being performed in accordance with a second clustering metric that is different from the first clustering metric; and (iii) after clustering the pairs assigned to the first phase, proceeding to the second phase of the clustering process, including clustering one or more other pairs in accordance with the second clustering metric; and
3. Deriving the geometrical paths from the clusters.

In an embodiment, for a given pair of tracklets originating from a given pair of cameras, the first clustering metric also considers tracklets originating from one or more cameras outside the pair of cameras. In a disclosed embodiment, the one or more processors are configured to form the clusters for the given time segment by: (i) creating a clustering graph including nodes and edges, the nodes representing tracklets or previously-clustered tracklets, (ii) assigning the edges respective triangle scores, a triangle score assigned to an edge being indicative of a number of triangles in the clustering graph in which the edge participates, and (iii) forming the clusters responsively to the triangle scores as the first clustering metric.

There is also provided, in accordance with an embodiment of the present invention, a tracking system including an interface, a memory, and one or more processors. The interface is configured to receive images acquired by a plurality of video cameras installed in a region. The memory is configured to store calibration geometrical positions and data that specifies orientations of respective Fields-Of-View (FOVs) of the cameras. The one or more processors are configured to, based on the images and the calibration data, distinguish between multiple individuals present in the region, and track geometrical paths taken by the individuals in the region, including: (i) defining, for a given camera, based on the calibration data, effective image boundaries that exclude image portions exceeding a defined distance criterion relative to the given camera, and (ii) distinguishing between the individuals and calculating the geometrical paths based only on content falling within the effective image boundaries.

There is further provided, in accordance with an embodiment of the present invention, a tracking system including an interface, a memory, and one or more processors. The interface is configured to receive images acquired by a plurality of video cameras installed in a region. The memory is configured to store calibration data that specifies geometrical positions and orientations of respective Fields-Of-View (FOVs) of the cameras. The one or more processors are configured to, based on the images and the calibration data: (i) distinguish between multiple individuals present in the region, including deciding that a given individual is observed consistently in the images by applying a defined spatiotemporal consistency criterion, and (ii) track geometrical paths taken by the individuals in the region. There is additionally provided, in accordance with an embodiment of the present invention, a tracking system including an interface, a memory, and one or more processors. The interface is configured to receive images acquired by a plurality of video cameras installed in a region. The memory is configured to store calibration data that specifies geometrical positions and orientations of respective Fields-Of-View (FOVs) of the cameras. The one or more processors are configured to, based on the images and the calibration data, distinguish between multiple individuals present in the region, and track geometrical paths taken by the individuals in the region, including: (i) calculating a first 3D position for a first time interval, based on two or more first 2D tracks having respective identifiers, (ii) calculating a second 3D position for a second time interval, based on two or more second 2D tracks having respective identifiers, and (iii) associating the first and second 3D positions with a same individual, in response to finding that the first 2D tracks and the second 2D tracks share at least one common identifier.

There is further provided, in accordance with an embodiment of the present invention, a tracking system including an interface, a memory, and one or more processors. The interface is configured to receive images acquired by a plurality of video cameras installed in a region. The memory is configured to store calibration data that specifies geometrical positions and orientations of respective Fields-Of-View (FOVs) of the cameras. The one or more processors are configured to, based on the images and the calibration data, distinguish between multiple individuals present in the region, track geometrical paths taken by the individuals in the region, and identify, based on the geometrical paths, a group of two or more individuals that are associated with one another.

In various embodiments, the one or more processors are configured to track the geometrical paths in real time.

The present invention will be more fully understood from the following detailed description of the embodiments thereof, taken together with the drawings in which:

### BRIEF DESCRIPTION OF THE DRAWINGS

FIG. 1 is block diagram that schematically illustrates a system for tracking of individuals based on video footage, in accordance with an embodiment of the present invention;

FIG. 2 is a flow chart that schematically illustrates a method for tracking carried out by the system of FIG. 1, in accordance with an embodiment of the present invention;

FIG. 3 is a diagram that schematically illustrates calculation of effective image boundaries, in accordance with an embodiment of the present invention;

FIG. 4 is a diagram that schematically illustrates a spatiotemporal consistency criterion, in accordance with an embodiment of the present invention; and

FIG. 5 is a diagram that schematically illustrates a backup association mechanism on shared based two-dimensional (2D) tracks, in accordance with an embodiment of the present invention.

### DETAILED DESCRIPTION OF EMBODIMENTS

### Overview

Embodiments of the present invention that are described herein provide improved techniques for real-time tracking of individuals based on video footage acquired by multiple cameras. The embodiments described herein refer mainly to tracking shoppers in a store. The disclosed techniques, however, are in no way limited to this application, and can be used in a wide variety of fields.

The disclosed techniques have two underlying assumptions:
1. The relevant region for tracking is densely covered by video cameras. In the present context, the term “dense” means that nearly every point in the relevant region falls in the Field-Of-View (FOV) of at least two different cameras, and usually more.
2. The cameras are calibrated, i.e., the positions and orientations of the cameras' FOVS in Three-Dimensional (3D) space are known. The calibration allows projecting 3D points to cameras, as well as de-projecting pixels to 3D rays.

In some embodiments, a disclosed tracking system comprises an interface and a processor. The interface is configured to receive images acquired by a plurality of video cameras installed in a region, e.g., a store. Based on the images and on a geometrical calibration of the cameras, the processor is configured to distinguish between multiple individuals present in the region, and to track geometrical paths taken by the individuals. The description that follows refers mainly to a typical embodiment in which the tracking operation is performed in real time. Alternatively, tracking may be performed off-line.

Typically, the input to the tracking process comprises (i) multiple streams of Two-Dimensional (2D) images acquired by the multiple video cameras, and (ii) calibration data indicating the geometrical positions of the cameras and the orientations of the cameras' FOVs. Typically, the streams of 2D images are temporally synchronized. The output of the process comprises a real-time stream of mappings between 2D detections of individuals and identifiers of individuals that are consistent across cameras and time. The output may also comprise a real-time stream of Three-Dimensional (3D) pose estimations for the individuals. Another possible output is a stream of group estimations, i.e., ongoing predictions that two or more of the individuals are likely to be associated with a group that acts (e.g., shops) together.

### System Description

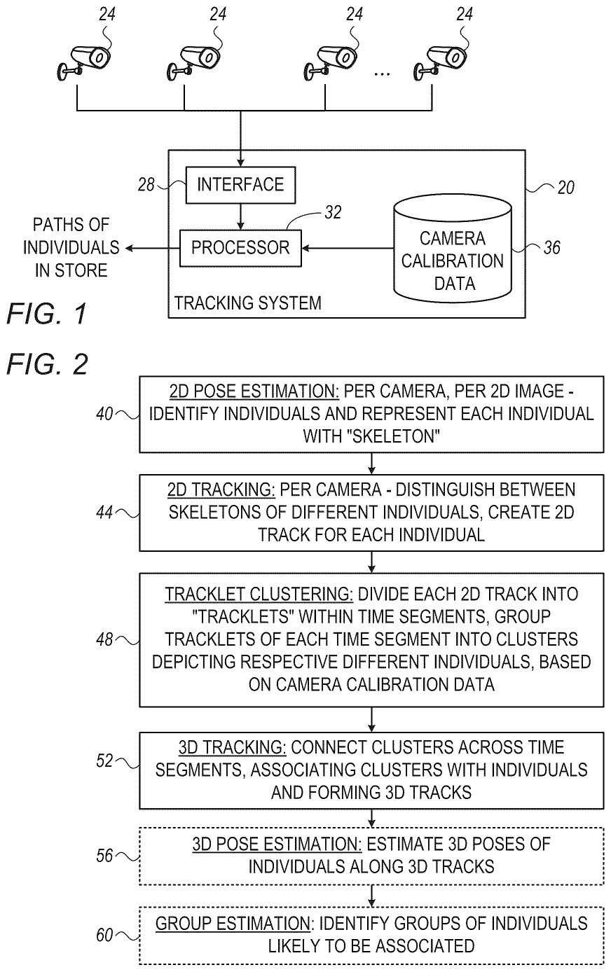

FIG. 1 is a block diagram that schematically illustrates a system 20 for tracking of individuals based on video footage, in accordance with an embodiment of the present invention. In the present example, system 20 is used for tracking paths traversed by shoppers in a retail store. The output of the tracking process can be used for various purposes, e.g., for automatic generation of a shopping list in an automated store or for theft prevention. It is noted that the disclosed tracking techniques are in no way limited to this application, and may be used for tracking individuals in any other suitable region-of-interest and for any other suitable purpose.

System 20 receives video images acquired by a plurality of video cameras installed in a region-of-interest, e.g., a store. In the example of FIG. 1, system 20 comprises an interface 28, a processor 32 and a memory 36. Interface 28 is used for receiving the images acquired by video cameras 24. Memory 36 stores calibration data that indicates the geometrical positions of the cameras and the orientations of the cameras' Fields Of View (FOVs). Processor 32 processes the images and the calibration data to (i) distinguish between multiple individuals present in the region, and (ii) track the geometrical paths taken by the individuals. These techniques are described in detail herein.

The configuration of system 20 shown in FIG. 1 is an example configuration that is chosen purely for the sake of conceptual clarity. In alternative embodiments, any other suitable system configuration can be used. For example, the tasks of processor 32 may be partitioned among multiple processors, collocated or otherwise. Elements that are not necessary for understanding the principles of the present invention have been omitted from the figures for clarity.

The various elements of system 20 may be implemented in hardware, e.g., in one or more Application-Specific Integrated Circuits (ASICs) or Field-Programmable Gate Arrays (FPGAs). Additionally or alternatively, elements of system 20 may be implemented using software, or using a combination of hardware and software elements. Memory 36 may comprise any suitable memory devices and/or storage devices.

In some embodiments, processor 32 comprises one or more general-purpose processors, which are programmed in software to carry out the functions described herein. The software may be downloaded to the one or more processors in electronic form, over a network, for example, or it may, alternatively or additionally, be provided and/or stored on non-transitory tangible media, such as magnetic, optical, or electronic memory.

### General Tracking Method Description

FIG. 2 is a flow chart that schematically illustrates a method for tracking carried out by system 20 of FIG. 1, in accordance with an embodiment of the present invention.

### 2D Pose Estimation

In a 2D pose estimation operation 40, processor 32 identifies individuals in the 2D images and represents each individual with a “skeleton”. In an embodiment, a skeleton comprises coordinates of the head, shoulders, elbows and wrists of an individual, in the 2D coordinate system of the camera 24 that acquired the image. In some embodiments, a skeleton also comprises a bounding box of the individual's head. The 2D pose estimation is performed separately per camera 24 and per image, in real time.

Subsequently, processor 32 carries out a 2D tracking operation 44, separately per camera 24. Within the stream of skeletons identified in the 2D images of a given camera, the processor distinguishes between skeletons of different individuals. For each individual, the processor creates a 2D track, which optimally (although not necessarily) covers the entire time period in which the individual appears in the FOV of the camera in question.

### Tracklet Clustering

In a tracklet clustering operation 48, processor 32 defines a timeline comprising a series of partially overlapping time segments. The duration of each time segment, and the amount of overlap between successive time segments, may be configurable. In an example implementation, the time segment duration is two seconds, and the overlap duration is one second. Alternatively, any other suitable durations can be used.

Processor 32 divides each 2D track into “tracklets”. In the present context, the term “tracklet” refers to the geometrical path of a given skeleton (representing a given individual) in the 2D coordinate system of a given camera 24 over a given time segment.

Processor 32 uses the camera calibration data (obtained from memory 36) to group together (“cluster”) tracklets from different cameras that are likely to represent the same individual, based on pairwise and higher-order distance metrics specified hereunder. In the present context, the term “cluster” refers to a set of one or more tracklets that (i) originate from one or more different cameras, (ii) occur in a given time segment, and (iii) are likely to represent the same individual. Given the calibration data, a cluster of two or more tracklets allows the calculation of the 3D locations or geometrical path of the individual during the time segment in question.

### 3D Tracking

In a 3D tracking operation 52, processor 32 strings together clusters over partially overlapping time segments, thereby associating clusters from different time segments with individuals. Each time segment comprises multiple clusters (produced tracklet clustering operation 48), ideally but not guaranteed to belong to different individuals. Within each cluster, tracklets ideally but not guaranteed to belong to the same person. The processor may allow more than one cluster for a given individual in a given time segment, accounting for possible imperfections of the clustering process.

In the 3D tracking operation, processor 32 constructs sequences of clusters, each sequence comprising clusters that advance in time and space and are likely to represent the 3D path of a given individual. Such a sequence is referred to as a “3D track”.

The output of the 3D tracking operation is a stream of mappings between 2D observations of individuals and identifiers of individuals that are consistent across cameras and time.

In a typical implementation, in each time segment, processor 32 associates clusters to individuals (rather than to other clusters), where the individuals are the result of the 3D tracking operation on the previous time segment, saved to the system memory.

### 3D Pose Estimation

In a 3D pose estimation operation 56, processor 32 estimates the 3D pose of each individual along that individual's 3D track. This block is marked as dashed in the figure as it may be considered optional or application dependent. Although 3D pose estimation may not be part of the 3D tracking process per se, it is an important building block in many applications. In an automated store application, for example, an individual's 3D pose is important for detecting and/or analyzing the interaction between the individual and a shelf, e.g., identifying actions like picking up or returning a product. One example of a robust 3D pose estimation process is described in U.S. Provisional Patent Application 63/752,887, cited above.

### Group Estimation

A subsequent group estimation operation 60, too, is marked as dashed in the figure since it may be considered optional or application dependent. Although not a strict part of 3D tracking, group estimation is extremely useful in many applications. In this operation, processor 32 analyzes the 3D tracks of the various individuals, and identifies groups of two or more individuals that are likely to be associated with one another. In a store environment, for example, the processor may identify two or more individuals that shop together. This identification can be important, for example, to automatically construct a joint shopping list for the group instead of a separate list per individual.

### DETAILED DESCRIPTION OF EXAMPLE FEATURES

The following section highlights example features of the disclosed tracking process. The features below significantly enhance the accuracy and computational efficiency of the tracking process. As a result, tracking system 20 is able to track complicated dense scenes containing a large number of individuals, using a large number of cameras 24, in real time. In an example implementation, a store is covered by approximately 1,000 video cameras, and system 20 is able to track hundreds of individuals simultaneously, in real time.

### Geometry-Aware Image Boundaries

In some embodiments, as part of 2D tracking operation 44, processor 32 defines “effective image boundaries” for a given camera 24, which are smaller than the actual frame boundaries. The effective image boundaries exclude portions of the image that are known to be too far from the camera to be useful or necessary.

In various embodiments, processor 32 may use various criteria for deciding which portions of the image to exclude. For example, in some embodiments the processor calculates the effective image boundaries based on (i) an assumption that the heights of all individuals of interest are below a configurable threshold (e.g., 230 cm), and (ii) a guarantee that every point in 3D space is covered by a minimal amount of “close” (typically a configurable threshold) cameras. The latter condition is typically met when using dense camera coverage.

Given the calibration data of a given camera, the assumptions above define portions of the camera's FOV (and thus of the 2D images produced by the camera) that can be safely excluded from subsequent processing (e.g., from generating 2D tracks). Subsequent processing is performed only on content falling within the effective image boundaries. The image portion falling outside the effective image boundaries is ignored.

In an example, the calibration data for a given camera specifies the height of the camera above floor level, the vertical inclination angle of the camera (“pitch”), and additional relevant information. Based on this information, processor 32 calculates the (inner) portion of the image that corresponds to rays along which the distance from the camera to a given horizontal plane is closer than a certain threshold distance. Alternatively, the processor may exclude portions of the image that exceed any other suitable distance criterion. The underlying assumption is that the excluded areas will be covered adequately by other, closer cameras. This condition is typically met when using dense camera coverage.

By considering only information found within the effective image boundaries, the accuracy of the entire tracking system is improved considerably. Discarding far and/or flat-angled portions of the frame allows the system to avoid mistakes that could otherwise mislead subsequent stages of the process.

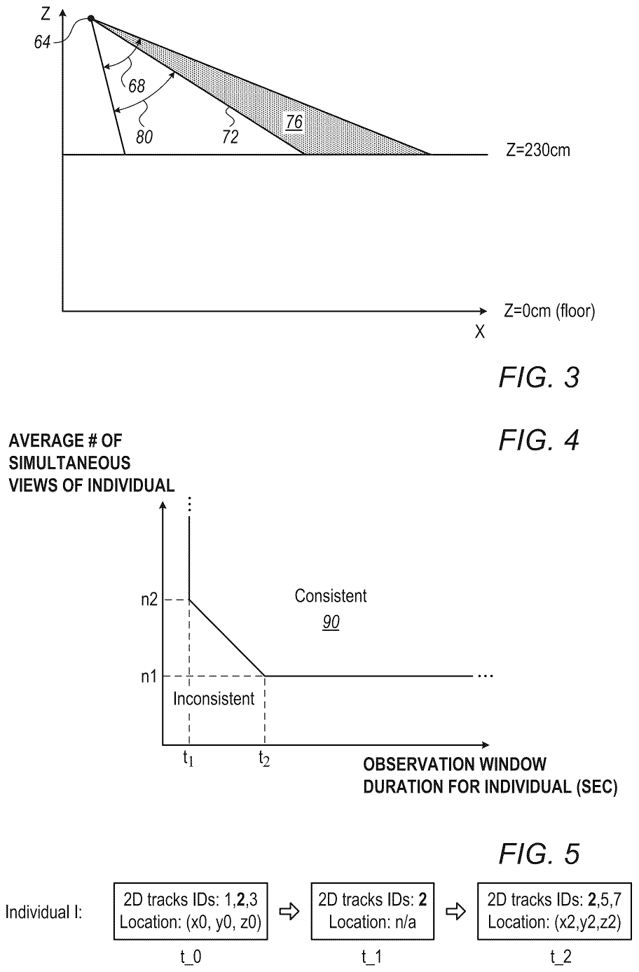

FIG. 3 is a diagram that schematically illustrates calculation of effective image boundaries by processor 32 for a certain camera 24, in accordance with an embodiment of the present invention. For ease of explanation, the example is depicted in two dimensions only, although an actual implementation would involve calculation in three dimensions.

The Z axis in FIG. 3 denotes height above floor level, and the X axis denotes lateral position. A point 64 marks the position of the camera 24 whose effective image boundaries are being calculated. A sector 68 marks the FOV of the camera. The position of point 64, and the position and orientation of sector 68, are obtained from the calibration data in memory 36.

In the present example, processor 32 aims to ignore parts of the camera's FOV that capture objects having Z>230 cm (assuming they cannot be humans), or objects having Z<230 cm but are necessarily more distant than a defined threshold distance 72 (assuming they are too distant to be useful, and assuming they will be better covered by other cameras).

Given these criteria, a sector marked 76 of the camera's FOV is ignored. A remaining sector, marked 80, is considered the effective image boundary for this camera.

### Clustering Metric

In some embodiments, in Tracklet Clustering operation 48, processor 32 determines the likelihood of whether a set of tracklets belongs to a cluster by calculating a “normalized reprojection error” metric for every relevant pair of tracklets. The “normalized reprojection error” is defined as the standard reprojection error, normalized by the scale of the object as it appears in each of the two respective cameras.

In the context of tracking individuals, a reprojection error is calculated between two head keypoints, seen in two different cameras, which is then normalized by the dimensions of the heads' respective bounding boxes. Intuitively this metric can be understood to measure the reprojection error in units of “heads”.

More formally, the normalized reprojection error is defined as follows:
1. Let xᵢ and yᵢ denote the x, y coordinates of an object in the image acquired by the i^{th} camera.
2. Let \hat{x}ᵢ and ŷᵢ denote the x,y coordinates of the reprojection to the i^{th} camera of the object's 3D triangulation.
3. Let wᵢ and hᵢ denote the width and height, respectively, of the object's bounding box in the image acquired by the i^{th} camera.
4. The normalized reprojection d is defined as

$$d = {\sum }_{i = 1}^{2} \sqrt{{( \frac{{x}_{i} - {\hat{x}}_{i}}{{w}_{i}} )}^{2} + {( \frac{{y}_{i} - {\hat{y}}_{i}}{{h}_{i}} )}^{2}}$$

In the presence of known camera aberrations, the “normalized reprojection error” is easily calculable, unlike other metrics such as “normalized epipolar distance”.

### Geometrical Multi-Camera Restrictions

One of the major sources of computational complexity in the tracking process is the tracklet clustering problem (operation 48), as the number of tracklet pairs to be considered naively is quadratic in the number of tracklets, which in turn is proportional to the number of individuals. Any side information (“restriction”), which rules out tracklets from belonging to the same cluster, will reduce the size of the clustering problem and thus save considerable runtime.

In some embodiments, processor 32 uses the camera calibration data to define geometrical restrictions that span tracklets originating from different cameras. In the present context, the term “geometrical restriction” refers to that indicates with high a criterion probability that two or more tracklets obtained from different cameras at the same time interval cannot be associated with the same individual.

In some embodiments, to evaluate multi-camera geometrical restrictions, processor 32 creates a “camera connectivity graph” comprising nodes and edges. Each node of the graph corresponds to a respective camera. An edge connecting two nodes indicates that the corresponding two cameras have overlapping FOVs.

In some embodiments, an indication of overlap between two FOVs (represented by a graph edge), also comprises polygons, that result from reprojecting the 3D volume contained in both frusta back to the respective cameras. These image-space polygons allow for more nuanced geometrical restrictions, thus further reducing the computational load. Namely, the image-space polygons allow inferring that two tracklets are restricted even when the respective pair of cameras have overlapping FOVs, by leveraging the tracklets' 2D locations in the respective images.

In some embodiments, processor 32 implements (e.g., records and updates) the restrictions within a collection of tracklets in a specialized data structure:
1. Restrictions are stored in a distributed way—each tracklet is associated with a collection of identifiers of other tracklets with which it cannot be clustered.
2. The collection of restricted identifiers associated with every tracklet is implemented as a list of “UUID hash sets”. In an example implementation:
   Different elements in the list originate from different time-stamps in the tracklet's respective time segment. Since subsequent time-stamps yield highly similar collections of restrictions, chaining (rather than merging) these collections is beneficial in terms of computation resources.
   A “UUID hash set” is defined as a hash set in which the hashing function is the identity function. Using a UUID hash set saves computation resources when the elements it stores are distributed uniformly, which indeed is the case for identifiers of tracklets (that in turn are implemented as randomly sampled UUIDS).

In some embodiments, further runtime enhancement is achieved by finding disjoint subsets of tracklets, such that tracklets in different subsets are restricted from being clustered together, and applying the “tracklets clustering” algorithm concurrently for different subsets. The disjoint subsets can be found by a standard connected-components algorithm applied to a graph in which nodes represent tracklets and edges indicate that the corresponding tracklets are not restricted from being clustered together.

### Phased Agglomerative Clustering

In an example embodiment, processor 32 uses a novel technique referred to as “phased agglomerative clustering” that in turn uses a metric referred to as “triangle score”. In this embodiment, the processor creates a “clustering graph” comprising nodes and edges. Each node of the graph corresponds to a tracklet (or a previously-clustered group of tracklets).

In some embodiments, every pair of nodes is connected by an edge. In other embodiments, pairs of nodes that are highly unlikely to be clustered together are not connected by an edge. Any suitable restriction criteria can be used for deciding which nodes should be initially connected by edges.

An edge connecting two nodes comprises the example, the “normalized clustering metric (for reprojection error” disclosed above), as well as the novel “triangle score”. The “triangle score” assigned by the processor to a given edge is indicative of the number of triangles (i.e., graph cycles comprising three nodes, or 3-cliques) in the graph in which that edge participates.

In some embodiments, only graph triangles in which all three clustering metric scores surpass a configurable threshold are accounted for in the “triangle score” calculation.

The “phased agglomerative clustering” technique aims to improve a traditional drawback of agglomerative of clustering—Greediness. A naîve implementation agglomerative clustering would attempt to progressively add tracklets to a cluster based on the clustering metric. This greedy progress may lead to irrecoverable clustering errors, as tracklets that belong to different individuals may sometimes have a misleading clustering metric (i.e., when the corresponding rays coincidentally intersect near-perfectly in 3D space).

Intuitively, the “triangle score” can be understood to express the degree of corroboration a potential connection between two tracklets has from other tracklets. The triangle score thus effectively discerns misleading connections (which stem from coincidental intersection of rays in 3D space, and are likely to have little to no corroboration) from correct ones.

In a disclosed embodiment, the processor divides the clustering process into two or more phases. Consider, for example, an implementation having two phases. In this embodiment, the processor divides the range of triangle scores (e.g., by setting a threshold) into a sub-range of high triangle scores and a sub-range of low triangle scores. In the first phase, clustering is attempted only among pairs of tracklets having high triangle scores. In the second phase, after the pairs of tracklets having high triangle scores have been exhausted, the processor proceeds to attempt clustering using pairs of tracklets having low triangle scores. Within each of the phases, the processor uses a pairwise clustering metric, which in some embodiments is the above-described “normalized reprojection error”.

In alternative embodiments, the processor may perform phased agglomerative clustering using more than two phases, by dividing the range of triangle scores into more than two sub-ranges. The process begins with the highest sub-range and progresses to lower sub-ranges.

It is noted that the concept of phased agglomerative clustering is applicable in a wide variety of applications that involve clustering, and is in no way limited to clustering of tracklets. Furthermore, phased agglomerative clustering is not limited to using “triangle score” as the metric for dividing the clustering problems into phases; other suitable pairwise or higher-order metrics can be used as an alternative. In other words, the triangle score is considered herein as example of a score that is indicative of the amount of corroboration from additional tracklets originating from additional cameras.

### Spatiotemporal Consistency Criteria

In executing 3D Tracking operation 52, processor 32 often encounters clusters that cannot be associated with individuals, i.e., clusters that are not close in 3D space and/or do not share 2D tracks with any individual known to the system. In some cases, an unassociated cluster may indicate a genuine “new” individual, e.g., an individual who just entered the store, or an individual who for some reason had been “lost” by the tracking system before and has now been reacquired. In other cases, however, an unassociated cluster is merely noise, stemming, for example, from incorrect 2D detections and/or imperfect clustering.

In various embodiments, processor 32 evaluates suitable temporal consistency criteria that aim to distinguish between valid “new” individuals and noise; the latter should be discarded. The intuition behind this approach is that noise usually does not repeat itself, and hence does not qualify as “temporally consistent”.

The design of a consistency criterion balances considerations of accuracy (the correctness of the real/noise decision) and latency (the time required to determine whether the new entity is real or noise).

For certain applications, latency is especially important. For example, in autonomous retail stores, latency of the consistency criterion effectively leads to losing the beginning of a shopper's journey, as well as any interactions with products it may contain.

In some embodiments, in a multi-view tracking system, the consistency criterion can leverage agreement across views (i.e., spatial consistency) as well as temporal consistency. This novel combination, referred to as “spatiotemporal consistency criterion” allows reducing the criterion's latency without impairing its accuracy.

FIG. 4 is a diagram that schematically illustrates a spatiotemporal consistency criterion, in accordance with an embodiment of the present invention. The underlying principle behind this criterion is that an individual seen by a large number of cameras (and is therefore very unlikely to be a random mistake) would qualify as consistent faster than an individual seen by fewer cameras.

The vertical axis in FIG. 4 denotes the average number of simultaneous views of a certain individual (i.e., the average number of different cameras in which the individual is seen during a frame interval). This value is denoted N. The horizontal axis denotes the lengths of different rolling time windows considered by the processor for the evaluation of the consistency criterion. This value is denoted T.

Various numerical values can be used. In the present example, n1=3 and n2=6. A region 90 marks the combinations of T and N that meet the spatiotemporal consistency criterion (i.e., combinations for which processor 32 considers the observation a genuine individual and not noise). Combinations of T and N that fall outside region 90 are considered inconsistent, i.e., do not meet the spatiotemporal consistency criterion.

As seen, up to an observation window of T=t1 second, the observation is considered inconsistent regardless of how many cameras capture the (alleged) individual simultaneously.

For an observation interval as short as T=t1 second, the average number of simultaneous views has to be relatively high (N>n2) for the observation to be declared consistent. For long observation intervals, from T=t2 and above, N>n1 is a sufficient value for meeting the spatiotemporal consistency criterion. Between T=t1 and T=t2 seconds, the threshold value of N is inversely proportional to T. Various numerical values can be used for t1 and t2. In the present example, t1=1 second and t2=4 seconds.

The criterion of FIG. 4 demonstrated the principle noted above—An individual seen by a large number of cameras (larger N) qualified as consistent more quickly (smaller T) than an individual seen by fewer cameras.

The shape of region 90 is an example shape that is chosen for the sake of conceptual clarity. In alternative embodiments, region 90 may have any other suitable shape that meets the above principle.

### Backup Association Logic in “3D Tracking” Based on Shared 2D Tracks

As explained above, in some embodiments processor 32 uses many-to-one cluster-to-individual association, which gives robustness to clustering mistakes. On top of association based on distances in 3D space, the processor may use a backup association mechanism based on identifiers of 2D tracks being shared between clusters and individuals.

This approach allows continuous tracking even when an individual is occasionally seen by a single camera and thus cannot be triangulated continually to 3D space. More generally, it allows tracking complex scenes in the presence of clustering mistakes and in the absence of 3D locations, as long as every individual in the scene can be clearly tracked in 2D by at least one camera.

FIG. 5 is a diagram that schematically illustrates a backup association mechanism based on shared two-dimensional (2D) tracks, in accordance with an embodiment of the present invention. The example of FIG. 5 shows the status of tracking a certain individual over three consecutive time intervals denoted t_0, t_1 and t_2.
1. In interval t_0, the individual in question is tracked by three different cameras, and is associated with three respective 2D tracks having IDs={1, 2, 3}. Based on the three views, processor 32 is able to derive 3D coordinates (x0, y0, z0) for the individual.
2. In interval t_1, the individual is tracked by a single camera only, the camera that captured the 2D track whose ID=2. With only a single view, processor 32 is unable to derive 3D coordinates for the individual in this interval.
3. In interval t_2, the individual in question is again tracked by three different cameras, and is associated with three respective 2D tracks having IDs={2, 5, 7}. Based on the three views, processor 32 derives 3D coordinates (x2, y2, z2) for the individual.

In this scenario, one of the cameras (the camera that captured the 2D track whose ID=2) viewed the individual in question during all three time intervals. In other words, 2D track ID=2 is common to t_0, t_1 and t_2. By using shared 2D the track, processor 32 associates the 3D positions of intervals t_0 and t_2 with the same individual, even though the two intervals are separated by an interval (t_1) in which the individual has no 3D position in the system.

In some embodiments, in order to ensure that the 2D backup association is safe and not misleading, a novel “tracking score” is employed, such that only 2D tracks that are very likely to be correct (i.e., very likely to follow the same individual) can be used to qualify a connection between a cluster and an individual. One possible tracking score is described in detail in U.S. Provisional Patent Application 63/752,887, cited above. Alternatively, however, any other suitable tracking score can be used.

### 3D Pose Estimation

In some embodiments, the 3D pose estimation process comprises two main stages:
1. Stage 1: Processor 32 applies a robust triangulation method (e.g., RANSAC) to account for possible “outliers”, which may be present, for example, because of clustering mistakes. Processor 32 begins by triangulating the head keypoints of an individual.
2. Stage 2: Other organs (e.g., shoulders, elbows and wrists) are then robustly triangulated using only 2D skeletons whose head keypoint was an inlier in Stage 1, thereby accounting for possible mistakes in the 2D skeletons (e.g., the hand of one individual associated with the head of another individual).

### Group Estimation

As noted above, in some embodiments processor 32 analyzes 3D tracks of various individuals, and identifies groups of two or more individuals that are likely to be associated with one another. The processor may use various criteria for declaring two or more individuals as a group.

In a store environment, for example, the processor may identify two or more individuals who (i) entered the store in close time proximity (e.g., within a defined time period), and (ii) were sufficiently close to each other (e.g., below a defined distance threshold) during at least a certain percentage of their journeys. Two or more individuals who meet this criterion would be considered a group. Alternatively, any other suitable criterion can be used.

As an example for an alternative criterion, in some embodiments, instead of defining a constant distance threshold, the processor may define a dynamic threshold which changes in space and time as a function of the local density of people. Such a criterion is not misled by dense scenes (e.g., people standing in a queue).

Although the embodiments described herein mainly address tracking of individuals in a retail store environment, the methods and systems described herein can also be used in any other application involving multi-view tracking in dense-coverage settings.

It will thus be appreciated that the embodiments described above are cited by way of example, and that the present invention is not limited to what has been particularly shown and described hereinabove. Rather, the scope of the present invention includes both combinations and sub-combinations of the various features described hereinabove, as well as variations and modifications thereof which would occur to persons skilled in the art upon reading the foregoing description and which are not disclosed in the prior art. Documents incorporated by reference in the present patent application are to be considered an integral part of the application except that to the extent any terms are defined in these incorporated documents in a manner that conflicts with the definitions made explicitly or implicitly in the present specification, only the definitions in the present specification should be considered.

1. A tracking system, comprising:
an interface, configured to receive images acquired by a plurality of video cameras installed in a region;
a memory, configured to store calibration data that specifies geometrical positions and orientations of respective Fields-Of-View (FOVs) of the cameras; and
one or more processors, configured to, based on the images and the calibration data, distinguish between multiple individuals present in the region, and track geometrical paths taken by the individuals in the region by:
calculating multiple tracklets, each tracklet defining a geometrical path of a given individual in a 2D coordinate system of a given camera over a time segment;
forming multiple clusters, each cluster comprising a set of one or more tracklets that (i) originate from one or more different cameras, (ii) occur in a given time segment, and (iii) are estimated to represent a same individual, including, in forming the clusters for a given time segment, applying a predefined geometrical restriction that rules out two or more tracklets obtained from from representing the same different cameras individual; and
deriving the geometrical paths from the clusters.

2. The system according to claim 1, wherein the one or more processors are configured to track the geometrical paths in real time.

3. A tracking system, comprising:
an interface, configured to receive images acquired by a plurality of video cameras installed in a region;
a memory, configured to store calibration data that specifies geometrical positions and orientations of respective Fields-Of-View (FOVs) of the cameras; and
one or more processors, configured to, based on the images and the calibration data, distinguish between multiple individuals present in the region, and track geometrical paths taken by the individuals in the region by:
calculating multiple tracklets, each tracklet defining a geometrical path of a given individual in a 2D coordinate system of a given camera over a time segment;
forming multiple clusters, each cluster comprising a set of one or more tracklets that (i) originate from one or more different cameras, (ii) occur in a given time segment, and (iii) are estimated to represent a same individual, including, for a given time segment, forming the clusters in a clustering process having at least first and second phases, by: (i) assigning one or more pairs of tracklets to the first phase of the clustering process, according to a first clustering metric, (ii) clustering the pairs assigned to the first phase, the clustering being performed in accordance with a second clustering metric that is different from the first clustering metric, and (iii) after clustering the pairs assigned to the first phase, proceeding to the second phase of the clustering process, including clustering one or more other pairs in accordance with the second clustering metric; and
deriving the geometrical paths from the clusters.

4. The system according to claim 3, wherein, for a given pair of tracklets originating from a given pair of cameras, the first clustering metric also considers tracklets originating from one or more cameras outside the pair of cameras.

5. The system according to claim 4, wherein the one or more processors are configured to form the clusters for the given time segment by:
creating a clustering graph comprising nodes and edges, the nodes representing tracklets or previously-clustered tracklets;
assigning the edges respective triangle scores, a triangle score assigned to an edge being indicative of a number of triangles in the clustering graph in which the edge participates; and
forming the clusters responsively to the triangle scores as the first clustering metric.

6. The system according to claim 3, wherein the one or more processors are configured to track the geometrical paths in real time.

7. A tracking system, comprising:
an interface, configured to receive images acquired by a plurality of video cameras installed in a region;
a memory, configured to store calibration data that specifies geometrical positions and orientations of respective Fields-Of-View (FOVs) of the cameras; and
one or more processors, configured to, based on the images and the calibration data, distinguish between multiple individuals present in the region, and track geometrical paths taken by the individuals in the region, including:
defining, for a given camera, based on the calibration data, effective image boundaries that exclude image portions exceeding a defined distance criterion relative to the given camera; and
distinguishing between the individuals and calculating the geometrical paths based only on content falling within the effective image boundaries.

8. The system according to claim 7, wherein the one or more processors are configured to track the geometrical paths in real time.

9. A tracking system, comprising:
an interface, configured to receive images acquired by a plurality of video cameras installed in a region;
a memory, configured to store calibration data that specifies geometrical positions and orientations of respective Fields-Of-View (FOVs) of the cameras; and
one or more processors, configured to, based on the images and the calibration data:
distinguish between multiple individuals present in the region, including deciding that a given individual is observed consistently in the images by applying a defined spatiotemporal consistency criterion; and
track geometrical paths taken by the individuals in the region.

10. The system according to claim 9, wherein the one or more processors are configured to track the geometrical paths in real time.

11. A tracking system, comprising:
an interface, configured to receive images acquired by a plurality of video cameras installed in a region;
a memory, configured to store calibration data that specifies geometrical positions and orientations of respective Fields-Of-View (FOVs) of the cameras; and
one or more processors, configured to, based on the images and the calibration data, distinguish between multiple individuals present in the region, and track geometrical paths taken by the individuals in the region, including:
calculating a first 3D position for a first time interval, based on two or more first 2D tracks having respective identifiers;
calculating a second 3D position for a second time interval, based on two or more second 2D tracks having respective identifiers; and
associating the first and second 3D positions with a same individual, in response to finding that the first 2D tracks and the second 2D tracks share at least one common identifier.

12. The system according to claim 11, wherein the one or more processors are configured to track the geometrical paths in real time.

13. A tracking system, comprising:
an interface, configured to receive images acquired by a plurality of video cameras installed in a region;
a memory, configured to store calibration data that specifies geometrical positions and orientations of respective Fields-Of-View (FOVs) of the cameras; and
one or more processors, configured to, based on the images and the calibration data, distinguish between multiple individuals present in the region, track geometrical paths taken by the individuals in the region, and identify, based on the geometrical paths, a group of two or more individuals that are associated with one another.

14. The system according to claim 13, wherein the one or more processors are configured to track the geometrical paths in real time.
